(19) United States
(12) Patent Application Publication
(10) Pub. No.: US 2005/0066504 A1
(43) Pub. Date: Mar. 31, 2005

(54) Fitting removal tool

(76) Inventors: Mark L. Duszynski, Osceola, IN (US); David B. Ton, Breman, IN (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/673,655

(22) Filed: Sep. 29, 2003

(51) Int. Cl. B23P 19/04

(52) U.S. Cl. 29/426.5; 29/258; 29/266

(57) ABSTRACT

An aircraft hydraulic/pneumatic fitting removal tool and related method of use for disengaging the locking collars of such fittings. In a particular embodiment, the fitting removal tool has a right cylindrical housing having a first and second end. Proximate to the second end is an internal circumferential pocket. An aperture is also provided in the second end, concentric to the longitudinal axis of the housing and accessing the circumferential pocket. An internal hollow channel extends from the circumferential pocket toward the first end. A threaded rod engages a threaded base in the first end, and passes into the hollow channel. A swivel seat is joined to the threaded rod within the hollow channel. The top portion of the housing from the second end to about halfway to the first end is removed laterally exposing a portion of the internal hollow channel, the swivel seat, the circumferential pocket, and the aperture. The opening in the top portion is sized to permit the tool to slip-fit on to the side of the fitting.

### FIELD OF THE INVENTION

This invention relates generally to hydraulic fitting removal tools and, in particular, to an aircraft hydraulic/pneumatic fitting removal tool used for disengaging the locking mechanism used by certain aircraft hydraulic fittings.

### BACKGROUND OF THE INVENTION

Modem aircraft, specifically commercial aircraft, frequently utilize high pressure fluid circuits commonly referred to as pneumatic or hydraulic systems to control and operate a wide variety of aircraft systems. From flight control systems such as flaps and ailerons to engine systems such as thrust reversers and safety systems such as door latches, hydraulic/pneumatic systems have proven highly reliable and generally superior to other systems. It is therefore not surprising that a modem commercial aircraft may have many miles of hydraulic pathways.

Although a common and often desirable characteristic of hydraulic/pneumatic systems is that the piping may be flexible and or formed into a variety of shapes, substantially rigid fittings are typically used to connect the ends of piping to housings or other structures. During operation, an aircraft may be subject to a number of vibration forces. In some instances these vibrations may be sufficient to loosen fittings. To combat this loosening tendency, fittings have been developed with locking systems intended to keep them in place and resist loosening over time, whether due to vibration or other stresses.

The developer of the present inventions, Honeywell International, Inc., has for years successfully designed, developed, manufactured and repaired aircraft hydraulic/pneumatic circuits and systems. One style of fittings frequently used is provided by Lourdes Industries, Inc. of Tucson, Ariz.

FIG. 1A shows a fitting 101 commonly referred to as a Lourdes fitting 101. Through the center of the fitting 101 runs a hollow passage, illustrated by dotted lines 103, from the open end 105 to permit the flow of hydraulic/pneumatic fluids through the fitting 101. This style of fitting 101 employs a locking collar 131 to prevent unintentional loosening of the fitting 101.

In general, the locking collar 131 is characterized as a ring with a circumferential groove 133, dividing the collar into what may appear as two fused rings, an inner ring 135 and an outer ring 137. Frequently the ring proximate to the mounting threads (the inner ring 135) is smaller in outside diameter then the ring farther away (the outer ring 137). The exterior surface of the locking collar 131 is characterized by vertical serrations or spines 139. The interior surface of the locking collar is mated to a plurality of vertical grooves 107 in the sidewall of the fitting body 109. These grooves insure that while the locking ring may be moved laterally along longitudinal axis 111 of the Lourdes fitting 101, represented by arrows 113, the fitting 101 cannot rotate independently from the locking collar 131. As desirable as these features may be during installation and for insuring that the fitting does not inadvertently loosen, they are often the source of great frustration to the technician attempting removal of the fitting.

After the fitting has been properly screwed into place, the locking collar 131 is pressed, pounded, or otherwise forced down into a provided annular groove in the mounting surface 183. The vertical grooves 107 are generally then visible above the locking collar 131 as shown in FIG. 1B. When the locking collar 131 has been properly forced down into the annular groove, the spines 139 of the locking collar 131 bind upon the material of the mounting surface 183. This binding action results in a firm hold that generally prevents the fitting from 101 unintentional loosening.

Removal of the Lourdes fitting 101 may be desired for a variety of maintenance tasks. To remove the Lourdes fitting 101 from the housing surface 183 into which it has been set, the locking collar 131 must be retracted from it's inset nested position. The circumferential groove 133 and the outer ring 135 of the locking collar 131 provide a location upon which a lever can be applied. For example, a technician may attempt to insert the tip of a blade screwdriver into the groove and pry the locking collar away from the housing. Such prying is generally quite difficult. The technician may also attempt to use some form of an axial pulling device.

Aircraft design and the conservation of weight and space continue to advance components into closer and tighter arrangements. It is now not uncommon for a desired Lourdes fitting to be installed in a location where it is extremely difficult if not nearly impossible for a technician to disengage the lock ring by traditional methods. Often, removal of the housing, and/or other components, may be required simply to provide sufficient access space for a prying screw driver to be applied.

Presently available and known fitting puller tools 161, shown in FIG. 1B, utilize expanding graspers such as hooks 163, or expanding halves 165 such as the Fairchild Fasteners Rosan fitting puller 167 shown in FIG. 1C. Use of either type of pulling device requires the target fitting 101 to be positioned well away from other structures 181, contoured surfaces 183 and/or components. More specifically, in order to grasp the fitting 101 to be pulled, the puller 161 first expands radially so that the grasping apparatus (hooks 163 or halves 165) can be placed around the target fitting 101. This radial expansion often results in the pulling device, (161 or 165) having a diameter that is significantly larger than the target fitting 101—perhaps even by 100%. Such a tool is completely unworkable in a setting where the fitting 101 is placed so closely to a component 181 that the puller can not align with the fitting 101 and or properly grasp the locking collar 131.

As stated above, the Lourdes fitting is designed to permit the passage of fluid through itself in line with it's longitudinal axis 111. Each end of the fitting is open and generally conically shaped to mate properly with connecting hosing or ports. As a result, the exposed end of an installed Lourdes fitting 101 does not provide a solid contiguous surface perpendicular to it's longitudinal axis 111 that a traditional pulling device may use as a fulcrum. Attempts to use traditional pulling devices may significantly damage the tapered end of the fitting, the locking collar 131, the spines 139, the vertical grooves 107, and or the fitting 101 itself, rendering the fitting 101 unable to properly seal with a connecting line. Traditional pulling devices may also damage, bend and or scrape the opening 105 and in so doing introduce foreign material (such as metal shavings or other debris) into the hydraulic/pneumatic circuit. Despite the high cost of such fittings, the relative probability of harm to the fitting is perceived as being so significant that generally all removed fittings are simply discarded.

Further, given the limitations of space it is often difficult for a technician to use more than one hand at a time due in part to limitations of space and or line of vision. The complexities of the tool and it's method of attachment may require the technician to apply both hands to hold the tool while a second technician attaches a wrench or retaining clamp. For example, the Rosan fitting puller 167 may require the outer housing 169 to be driven down onto the expanding halves 165 in order to set the tool upon fitting 101.

Hence, there is a need in for an improved aircraft fitting removal tool with improved characteristics to overcome one or more of the drawbacks identified above. The present invention satisfies one or more of these needs.

### SUMMARY OF THE INVENTION

The invention provides an aircraft hydraulic/pneumatic fitting removal tool and related method of use for disengaging the locking collars of such fittings.

In particular, and by way of example only, according to an embodiment of the present invention, this invention provides a fitting removal tool for retracting the locking collar of an open ended hydraulic/pneumatic fitting. The removal tool provides a seat structured and arranged to seat against the open end of the fitting; a housing structured and arranged to house the seat; an adjustable actuator structured and arranged to laterally actuating the seat within the housing; a swivel structured and arranged to maintaining the seat in a given orientation; and an attacher integral to the housing, the attacher structured and arranged to attach the housing to the locking collar of the fitting.

Moreover, according to an embodiment thereof, the invention may provide a fitting removal tool for retracting the locking collar of an open ended hydraulic/pneumatic fitting, the removal tool characterized by a housing having an internal channel partially along a longitudinal axis. A swivel seat is disposed within the internal channel and is configured to engage the open end of the fitting. An adjustable actuator is coupled to the swivel seat and configured to laterally actuate the swivel seat within the internal channel. An attacher, integral to the housing, is also provided and configured to attach the housing to the locking collar of the fitting.

In another embodiment, the invention may provide a fitting removal tool for retracting the locking collar of an open ended hydraulic/pneumatic fitting, the removal tool characterized a right cylindrical housing having a first end, a second end, a longitudinal axis therebetween. Further the housing may provide a base in the first end, an internal pocket, proximate to the second end and transverse to the longitudinal axis and an aperture in the second end, concentric to the longitudinal axis. An internal channel, concentric to the longitudinal axis extends from the pocket towards the first end. A swivel seat is coupled to the adjustable actuator and disposed within the internal channel.

In yet another embodiment, the invention may provide a method of retracting the locking collar of an open ended hydraulic/pneumatic fitting using a removal tool. The removal tool is characterized by a cylindrical housing having a first end, a second end, a partially exposed internal channel concentric to the longitudinal axis, a pocket transverse to the longitudinal axis and proximate to the housing second, an adjustable actuator extending through the first end into the internal channel and joined to a swivel seat disposed and laterally actuated within the internal channel. The method of removal involves actuating the adjustable actuator in a first direction to retract the swivel seat within the slot and placing the removal tool parallel to the fitting such that the partially exposed internal channel and pocket are presented to the fitting. The pocket is then slip-fit over the locking collar of the fitting. Actuating the adjustable actuator in a second direction advances the swivel seat to engage the open end of the fitting. Force is then applied by driving the adjustable actuator in the second direction, the force through the base providing a lateral motion of the cylindrical housing relative to the swivel seat engaging the open end of the fitting.

These and other features and advantages of the preferred apparatus and method will become apparent from the following detailed description taken in conjunction with the accompanying drawings which illustrate, by way of example the principles of the invention.

### BRIEF DESCRIPTION OF THE DRAWINGS

FIG. 1A is a prior art hydraulic/pneumatic fitting;

FIGS. 1B and 1C illustrate prior art pulling devices attempting removal of the fitting in FIG. 1A;

FIG. 2A shows a fitting removal tool according to a preferred embodiment of the present invention;

FIG. 2B shows a cutaway of the fitting removal tool shown in FIG. 2A;

FIG. 2C shows an exploded view of the fitting removal tool shown in FIG. 2A;

FIG. 2D shows an enlarged end view of the fitting removal tool shown in FIG. 2A;

FIGS. 3A through 3C illustrate use of the fitting removal tool shown in FIG. 2A;

FIG. 4 shows the fitting removal tool shown in FIG. 2A attached to the fitting of FIG. 1A.

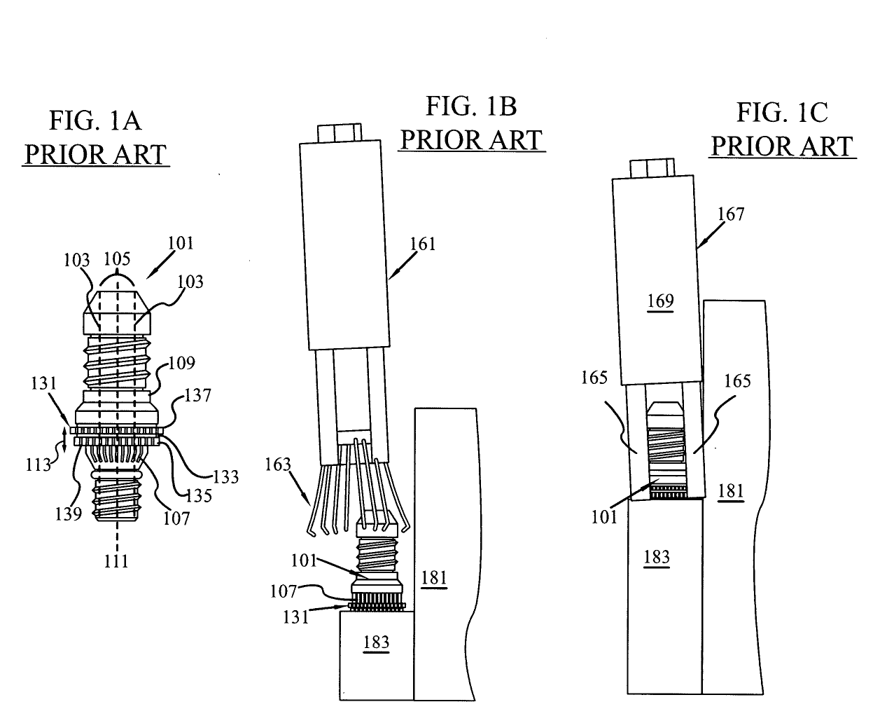

### DETAILED DESCRIPTION

Before proceeding with the detailed description, it is to be appreciated that the present invention is not limited to use or application with a specific type of aircraft hydraulic/pneumatic fitting removal tool. Thus, although the present invention is, for the convenience of explanation, depicted and described with respect to one type of aircraft hydraulic/pneumatic fitting employing an annular locking collar, this invention may be applied to other types and styles of fitting removal tools.

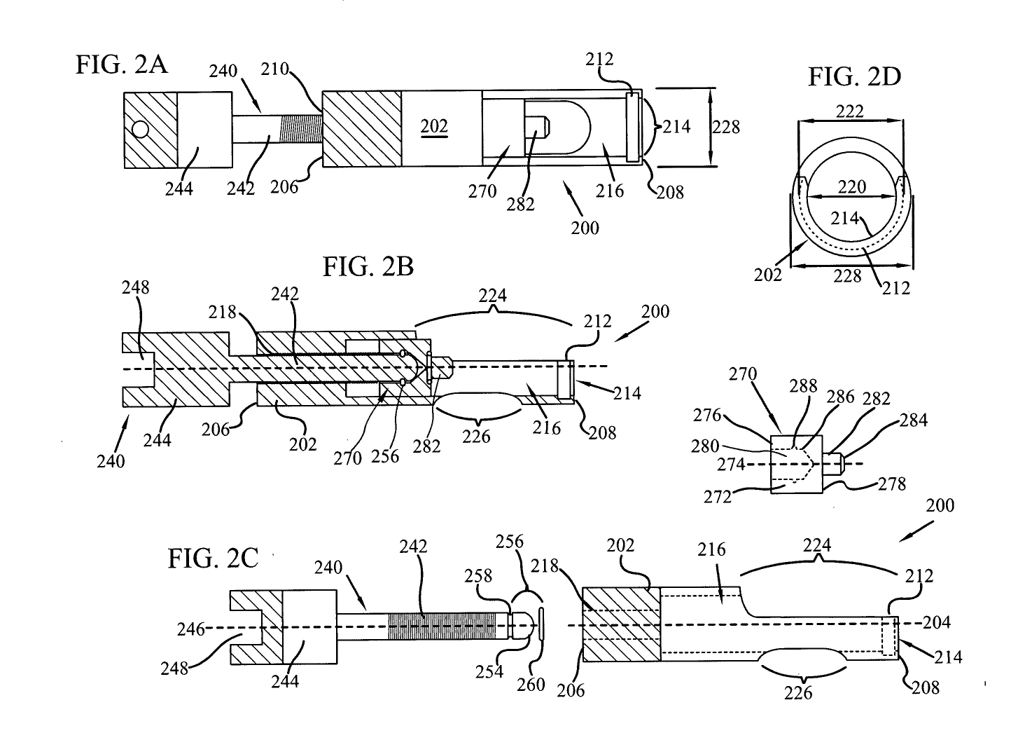

Turning now to the drawings, FIG. 2 shows a fitting removal tool 200 embodying the present invention. The fitting removal tool 200 has a right cylindrical housing 202, an actuator 240 and a swivel seat 270. These components may be more fully appreciated with reference to the cutaway and exploded views provided in FIGS. 2B and 2C.

The housing 202 may be characterized as having a longitudinal axis 204, first end 206, a second end 208, a base 210 for the actuator 240, an internal circumferential pocket 212, an aperture 214, and an internal hollow channel 216. As shown, the first end 206 and second end 208 are substantially transverse to the longitudinal axis 204. The base 210 may be located in the first end 206, and in at least one embodiment the base may include a threaded hole 218 concentric to the longitudinal axis 204. The pocket 212 may be proximate to the second end 208 and transverse to the longitudinal axis 204. The aperture 214 may be located in the second end 208 concentric to the longitudinal axis 204, and accessing the pocket 212. To maintain the outer boundary of the pocket 212, the diameter 220 of the aperture 212 is smaller than the diameter 222 of the pocket 212 (see face view of second end FIG. 2D). The internal hollow channel 216 is concentric to the longitudinal axis 204 and extends from the inner boundary of pocket 212 towards the first end 206.

So as to permit the fitting removal tool 200 to grasp the locking collar 131 of a fitting to be removed, an opening 224 is provided in the side of housing 202. In the depiction, the opening 224 extends from the housing second end 208 to about halfway to the housing first end 206, and laterally exposes a portion of the internal hollow channel 216, the pocket 212 and the aperture 214. In at least one embodiment, the opening 224 and exposed portions of the hollow channel 216, the pocket 212 and the aperture 214 are appropriately sized and shaped to permit the housing 202 to be slip-fit over a fitting 101 intended for removal. A viewing window 226 may be provided opposite from the opening 224 so that the technician may view the fitting 101 from both sides of the fitting removal tool 200.

As used herein, the terms of “slip-fit” shall be understood and appreciated to imply that tilting the housing 202 is not required to place the housing about the fitting 101. Moreover, when the fitting removal tool 200 is oriented to be next to, and substantially parallel to, the fitting 101, a sliding motion perpendicular to the longitudinal axis 204 will place the housing 204 substantially about the fitting 101 while maintaining substantial parallelism.

The outside diameter 228 of the housing 202 may be substantially uniform across the entire length of the housing 202 (see FIGS. 2A and 2D). In addition, in at least one embodiment the outside diameter of the housing 202 is substantially equal to or less than the outside diameter of the drive socket initially used to install the fitting 101. Further, the diameter of pocket 212 is substantially preset and non-expandable, requiring no radial expansion to engage the fitting 101.

In at least one embodiment, the adjustable actuator 240 is a threaded rod 242 coupled to a grip 244. Threaded rod 242 passes through mated threaded hole 218 in the first end 206 of the housing 202. As shown, the longitudinal axis 246 of the threaded rod 242 substantially matches to the longitudinal axis 204 of the housing 202.

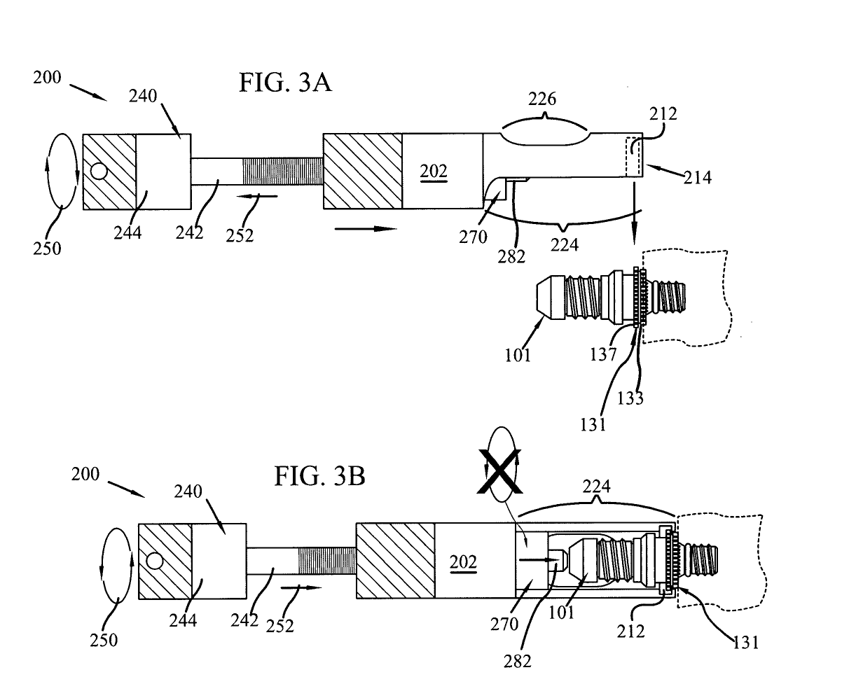

Grip 244 may be sized and shaped to be easily grasped and rotated by a technician. More specifically, as grip 244 is rotated by a technician, the rotation of grip 244 is directly imparted to threaded rod 242. Grip 244 may further provide a socket 248 of an appropriate nature to accommodate removably attaching a lever or driver, such as, for example, a three-eights inch square ratchet driver. It is understood and appreciated that rotation, represented by arrows 250, of grip 244 imparts lateral motion, represented by arrows 252, to threaded rod 242 towards or away from pocket 212 (see FIGS. 3A and 3B).

Opposite from the grip 244, the threaded rod 242 may be appropriately sized and shaped to join with swivel seat 270. More specifically, the end 254 may be rounded and provide an attacher 256 suitable for joining the threaded rod 242 to the swivel seat 270. In at least one embodiment such an attacher 256 may be a circumferential groove 258 substantially transverse to longitudinal axis 246, and associated snap ring 260.

In at least one embodiment, threaded rod 242 and grip 244 may be fabricated from a unitary block of metal. Under appropriate circumstances, other methods of coupling the rod 242 to the grip 244 may be employed such as glue, welding, press fitting, threaded fitting, or set screws.

The threads of rod 242 and the threads of mated threaded hole 208 may be sufficiently fine and snug to each other such that threaded rod 242 will remain at a fixed position when the technician ceases rotation of grip 244. More specifically, threaded rod 242 may support a load force without spontaneous rotation.

As shown in FIG. 2B, the swivel seat 270 is disposed in the internal hollow channel 216 and joined by the attacher 256 to threaded rod 242. The swivel seat 270 is structured and arranged to seat against an aperture, and more specifically, to do so without damaging the aperture or it's surrounding material. With respect to fitting 101, the aperture is the open end 105 of the fitting 101.

In at least one embodiment, the swivel seat 270 includes as a hollowed cylindrical body 272 having a longitudinal axis 274, a first end 276, a second end 278, an internal cylindrical opening 280, and a pilot 282 (see exploded view FIG. 2C). The internal cylindrical opening 280 extends from the second end 276 inwardly towards the first end 278. The internal cylindrical opening 280 is sized to accept the rounded end 254 of the threaded rod 242.

The pilot 282 is substantially perpendicular to the first end 278 and extends concentrically along the longitudinal axis 274. The outside diameter of the pilot 282 may be sized to about the same dimension as the inside diameter of the open end 105 of the fitting 101, the pilot thereby snuggly fitting within the open end 105 of the fitting 101. In addition, the distal end 284 of the pilot 282 may be conically tapered to assist with aligning the pilot 282, and thereby the fitting removal tool 200, with the fitting 101. More specifically, pilot 282 advantageously permits the swivel seat 270 to engage the open end 105 of fitting 101.

Around the internal sidewall 272 of the opening 280, and transverse to the longitudinal axis 274, a circumferential groove 274 is preferably formed. The internal circumferential groove 274 may be appropriately sized and shaped to receive the snap ring 260 of threaded rod 242 as end 254 is inserted into the opening 280 to join swivel seat 270 to threaded rod 242.

A friction reducing material such as oil, graphite, Teflon or other lubricious material tending to promote easy swiveling may also be applied or deposited to/between the end 254 of the threaded rod 242 and the internal cylindrical opening 280 of the swivel seat 270. The swivel seat 270 maintains substantially a constant orientation relative to the engaged open end 105 of the fitting 101 as the threaded rod 242 is rotated. Swivel seat 270 advantageously permits the fitting removal tool 200 to engage the open end 105 of the fitting 101 and apply a substantial pulling force without marring, gouging, scraping, or otherwise damaging the precisely machined conical end 113 of the fitting 101.

In the assembled form of the fitting removal tool 200, the longitudinal axes (204, 246 and 274) are substantially aligned. As such, rotation of threaded rod 242 results in transitive motion of the housing 202 towards the grip 244 with the swivel seat 270 engaged to fitting 101.

The integral nature of the pocket 212 to the housing 202 directs that as overall housing 202 moves, so to does the pocket 212. Engaging the locking collar 131, the lateral motion of the pocket 222 towards the grip 244 affectively disengages the locking collar 131 from the mounting surface 183, thus permitting the fitting 101 to be removed.

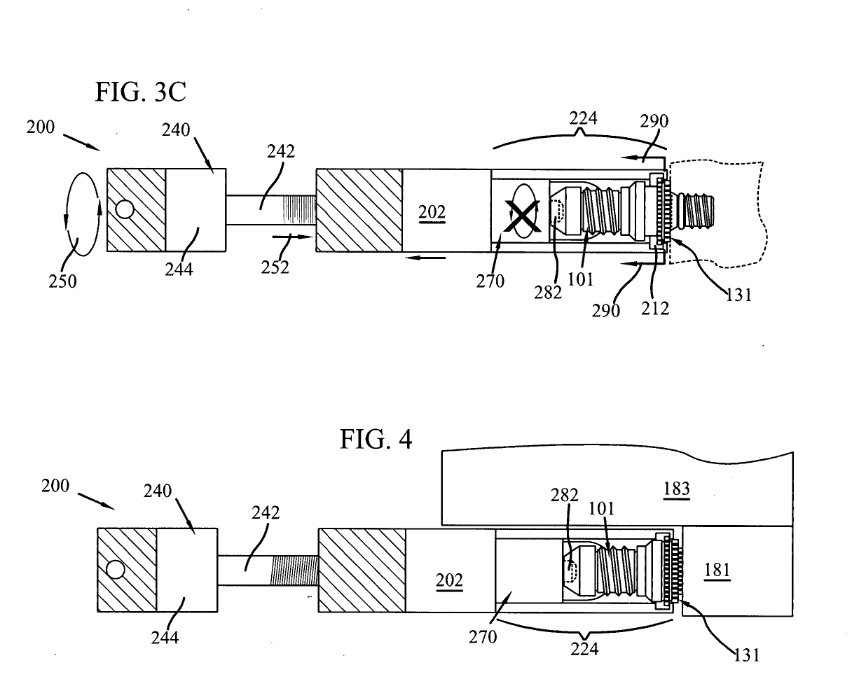

It is appreciated that fitting removal tool 200 permits extraction of the locking collar 131 without imparting significant torsion stress or rotation force to the fitting 101, either of which are likely to damage the serrations of the locking collar, the mounting flange, the open end 105 of the fitting 101, and/or the fitting 101 itself. Advantageously, fabricated with an outside diameter 228 substantially similar to that of the socket used to install the fitting 101, use of the fitting removal tool 200 generally is not impeded by close structures 181, as conceptually illustrated in FIG. 4.

It is further appreciated that the fitting removal tool 200 is sized and arranged to facilitate easy deployment by a technician as a one-handed tool. In addition, the external surface of the cylindrical housing 202 and or the grip 244 may be knurled or otherwise machined, coated or treated to facilitate easy manipulation by the technician.

Having described the above physical embodiment of the fitting removal tool 200, another embodiment relating to the method of employing the fitting removal tool 200 to disengage the locking collar 131 of a fitting 101 will now be described with reference to FIGS. 3A, 3B and 3C. It will be appreciated that the described method need not be performed in the order in which it is herein described, but that this description is merely exemplary of one method of using the fitting removal tool 200 in accordance with the present invention.

As noted above, modem aircraft incorporate substantial numbers of hydraulic/pneumatic fittings 101 many of which are frequently mounted in limited access locations. The presence of a fitting 101 generally suggests that there is sufficient surrounding space to accommodate a drive socket as may have been employed to install the fitting 101.

In general, the technician may commence the removal process by rotating the grip 244 to retract the swivel seat 270 within the internal hollow channel 216, shown in FIGS. 2A˜2C. Generally the swivel seat 270 is retracted such that opening 224 is substantially unobstructed and ready to receive the exposed portion of fitting 101. The technician now positions the removal tool 200 parallel to the desired fitting 101 and rotates the tool 200 such that opening 224 is presented to the fitting 101. More specifically, the technician aligns the opening 224 such that aperture 214 is set to engage the circumferential groove 133 of the locking collar 131. The pocket 212 is preferably therefore aligned to receive and substantially encompass the outer ring 137 of the locking collar 131, and the internal channel is set to accommodate the exposed top portion of the fitting 101.

The removal tool 200 is then simply slip-fit onto the fitting 101 from the side. When fitting removal tool 200 is slip-fit over fitting 101, the pocket 212 is engaged substantially around the locking collar 131. Advantageously over the prior art, use of the fitting removal tool 200 does not require substantial uniform extra space surrounding the fitting 101, but generally only enough space to accommodate placement of the fitting removal tool 200 adjacent to one side of the fitting 101.

As shown in FIG. 3B, the technician may rotate 250 the grip 244 in the appropriate manner to cause threaded rod 242 to advance 252 swivel seat 270 towards the open end 105 of fitting 101. As the pilot 282 engages opening of the fitting 101, the tapered form of the pilot 282 may assist in properly aligning the fitting removal tool 200 to the fitting. Generally the technician will continue rotation of the grip 244 until the swivel seat has substantially engaged the fitting 101. The placement and initial rotation of the grip 244 may advantageously be performed with only one hand—a desired ability in instances where the fittings have been installed with limited view and hand/tool space. When the fitting removal tool 200 has been initially attached to the fitting 101, the technician may let go of the fitting removal tool 200 with relative confidence that it will not accidentally fall or shift in position.

Extraction of the locking collar 131 is accomplished by the technician's appropriate rotation 250 of threaded rod 242 through the threaded base 210. Specifically, the technician torques the grip 244 with sufficient force to induce the threads of the rod 242 to pass through the threads of the base 210. The threads mechanically translate the rotation force into a lateral motion force. Acting as an inclined plane, the threads permit the technician to overcome the large resistance force by applying a relatively small force through a longer distance. As the swivel seat 270 is braced against the fitting, the lateral motion of the threaded rod 242 is not permitted. A substantially equal and opposite lateral force of motion, represented by arrows 290 results. A lateral motion of the housing 202 toward the grip 244 naturally results.

The integral nature of the pocket 212 to the housing 202 directs that as overall housing 202 moves, so to does the pocket 212. Engaged about the locking collar 131, the lateral motion of the pocket 212 effectively disengages the locking collar 131 from the mounting surface 183, thus permitting the fitting 101 to be removed. The mating of the pocket 212 and the locking collar 131 provides sufficient friction to substantially prevent rotation of the housing 202 relative to the fitting. Under appropriate circumstances, the vertical sidewalls of the pocket parallel to the longitudinal axis 204 may provide vertical notches to engage the vertical serrations of the locking collar 131. To provide a sufficient torque load to drive the threaded rod 242, and correspondingly a greater lateral pulling force, the technician may use a ratchet driver with socket 248.

Generally speaking, the fitting removal tool 200 is intended primarily for the purpose of disengaging the locking collar 131. As the fitting removal tool 200 is, by design, intended to substantially prevent rotational torque from being applied to the fitting 101, following the retraction of locking collar 131, the fitting removal tool 200 is generally removed so that a drive socket may be placed over fitting 101. The fitting removal tool 200 may be simply disengaged from the fitting 101 by rotating the grip appropriately to retract the swivel seat 270 from the fitting 101. As the pulling force applied by the fitting removal tool 200 is in substantially direct alignment with the fitting 101 due to the cooperation of the swivel seat 270 and the pilot 212, the process of extracting the locking collar 131 is substantially non-violent. Advantageously, with due inspection, the fitting 101 removed with the use of the fitting removal tool 200 may under appropriate circumstances be recycled for use at a significant cost savings over simple discard and replacement.

While the invention has been described with reference to the preferred embodiment, it will be understood by those skilled in the art that various alterations, changes and improvements may be made and equivalents may be substituted for the elements thereof and steps thereof without departing from the scope of the present invention. In addition, many modifications may be made to adapt to a particular situation or material to the teachings of the invention without departing from the essential scope thereof. Such alterations, changes, modifications, and improvements, though not expressly described above, are nevertheless intended and implied to be within the scope and spirit of the invention. Therefore, it is intended that the invention not be limited to the particular embodiments disclosed as the best mode contemplated for carrying out this invention, but that the invention will include all embodiments falling within the scope of the appended claims.

1. A fitting removal tool for retracting the locking collar of an open ended hydraulic/pneumatic fitting comprising:
a seat structured and arranged to seat against the open end of the fitting;
a housing structured and arranged to house the seat;
an adjustable actuator structured and arranged to laterally actuating the seat within the housing;
a swivel structured and arranged to maintaining the seat in a given orientation; and
an attacher integral to the housing, the attacher structured and arranged to attach the housing to the locking collar of the fitting.

2. A fitting removal tool for retracting the locking collar of an open ended hydraulic/pneumatic fitting comprising:
a housing having an internal channel partially along a longitudinal axis;
a swivel seat disposed within the internal channel configured to engage the open end of the fitting;
an adjustable actuator coupled to the swivel seat and configured to laterally actuate the swivel seat within the internal channel; and
an attacher integral to the housing and configured to attach the housing to the locking collar of the fitting.

3. The fitting removal tool of claim 2, wherein the attacher is not radially expandable.

4. The fitting removal tool of claim 2, wherein the attacher is slip-fit onto the locking collar of the fitting.

5. The fitting removal tool of claim 2, wherein the fitting removal tool is sized and shaped to permit one-handed operation.

6. The fitting removal tool of claim 2, wherein the housing is further characterized as a right cylindrical housing having a first end and a second end.

7. The fitting removal tool of claim 6, wherein the attacher is further characterized by an internal pocket, proximate to the second end and transverse to the longitudinal axis and an aperture in the second end providing access to the pocket.

8. A fitting removal tool for retracting the locking collar of an open ended hydraulic/pneumatic fitting comprising:
seating means for seating against the open end of the fitting;
housing means for housing the seating means;
actuating means for laterally actuating the seating means within the housing means;
swivel means for maintaining the orientation of the seating means during actuation; and
attaching means integral to the housing means for attaching the housing means to the locking collar of the fitting.

9. The fitting removal tool of claim 8, wherein the attaching means is not radially expandable.

10. The fitting removal tool of claim 8, wherein the attaching means is slip-fit onto the locking collar of the fitting.

11. The fitting removal tool of claim 8, wherein the fitting removal tool is sized and shaped to permit one-handed operation.

12. A fitting removal tool for retracting the locking collar of an open ended hydraulic/pneumatic fitting comprising:
a right cylindrical housing having a first end, a second end, a longitudinal axis therebetween, and further characterized by:
a base in the first end;
an internal pocket, proximate to the second end and transverse to the longitudinal axis;
an aperture in the second end, concentric to the longitudinal axis;
an internal channel, concentric to the longitudinal axis and extending from the pocket towards the first end; and
an adjustable actuator extending through the base and passing into the internal channel; and
a swivel seat coupled to the adjustable actuator and disposed within the internal channel.

13. The fitting removal tool of claim 12, wherein the adjustable actuator is a threaded rod passing through a mated threaded hole in the base.

14. The fitting removal tool of claim 13, further comprising a grip mounted to the threaded rod opposite from the swivel seat.

15. The fitting removal tool of claim 14, wherein the grip further provides a socket for removable attachment of a lever.

16. The fitting removal tool of claim 15, wherein the lever is a ratchet driver.

17. The fitting removal tool of claim 12, wherein the aperture opens to the pocket.

18. The fitting removal tool of claim 12, wherein the pocket is circumferential.

19. The fitting removal tool of claim 12, further comprising an opening in the housing extending from the housing second end to at least partially beyond the pocket, wherein the opening exposes a portion of the pocket and the aperture.

20. The fitting removal tool of claim 19, wherein the opening extends to about halfway to the housing first end.

21. The fitting removal tool of claim 19, wherein the exposed portion of the pocket and aperture are structured and arranged to slip-fit onto the locking collar of the fitting.

22. The fitting removal tool of claim 12, wherein the swivel seat is structured and arranged to seat against an aperture.

23. The fitting removal tool of claim 22, wherein the aperture is the open end of the fitting.

24. The fitting removal tool of claim 23, wherein the swivel seat further has a pilot with an outside diameter sized to about substantially the same as the inside diameter of the open end of the fitting, the pilot thereby snuggly fitting within the open end.

25. The fitting removal tool of claim 24, wherein the pilot is conically tapered to assist with aligning the pilot to the open end of the fitting.

26. The fitting removal tool of claim 23, wherein the swivel seat maintains a constant orientation relative to the engaged open end of the fitting as the adjustable actuator is actuated.

27. The fitting removal tool of claim 12, wherein the internal channel is substantially about two-thirds of the length of the housing.

28. The fitting removal tool of claim 12, wherein the fitting removal tool is sized and shaped to permit one-handed operation.

29. A method of retracting the locking collar of an open ended hydraulic/pneumatic fitting using a removal tool having a cylindrical housing having a first end, a second end, a partially exposed internal channel concentric to the longitudinal axis, a pocket transverse to the longitudinal axis and proximate to the housing second end, an adjustable actuator extending through the first end into the internal channel and joined to a swivel seat disposed and laterally actuated within the internal channel, the method comprising:
actuating the adjustable actuator in a first direction to retract the swivel seat within the slot;
placing the removal tool parallel to the fitting such that the partially exposed internal channel and pocket are presented to the fitting;
slip-fitting the pocket over the locking collar of the fitting;
actuating the adjustable actuator in a second direction to advance the swivel seat to engage the open end of the fitting; and
applying force by driving the adjustable actuator in the second direction, the force through the base providing a lateral motion of the cylindrical housing relative to the swivel seat engaging the open end of the fitting.

30. The method of claim 29, wherein the adjustable actuator is a threaded rod passing through a mated threaded hole in the housing first end.

31. The method of claim 30, wherein the applied force is provided by torquing the threaded rod, the torquing achieved with a driver removably attached to the threaded rod.

32. The method of claim 29, wherein operation of the fitting removal tool may be performed with one hand.

33. The method of claim 29, wherein the slip-fitting is performed by sliding the removal tool perpendicularly to the longitudinal axis so as to maintain parallelism between the removal tool and the fitting.
